(19) United States
(12) Patent Application Publication
(10) Pub. No.: US 2017/0019919 A1
(43) Pub. Date: Jan. 19, 2017

(54) UE Triggering of Pre-Scheduled Uplink Grants Based on VoLTE Traffic

(71) Applicant: Apple Inc., Cupertino, CA (US)

(72) Inventors: Huarui Liang, Beijing (CN); Xugang Song, Beijing (CN); Yanxia Wang, Beijing (CN)

(21) Appl. No.: 15/209,912

(22) Filed: Jul. 14, 2016

(30) Foreign Application Priority Data
Jul. 15, 2015 (CN) 201510415505.9

(51) Int. Cl. H04W 72/14; H04L 29/08; H04W 76/04; H04W 72/04

(52) U.S. Cl. CPC H04W 72/14; H04W 72/04; H04L 69/324; H04W 76/048; H04W 88/02

(57) ABSTRACT

A pre-allocation grant schedule for communications between a wireless communication device (UE device) and a base station may be conducted according to requests made by the UE device. The UE device may provide information to a base station, requesting the base station to end a previous pre-allocation schedule and/or to start a new pre-allocation schedule. A request for stopping a previous pre-allocation schedule and starting a new pre-allocation schedule may be transmitted at the same time or in subsequent frames, respectively, depending on whether transition is from talk to non-talk mode or non-talk to talk mode. The base station may determine a pre-allocation schedule using the information received from the UE device, and may begin communicating uplink grants to the UE device according to the pre-allocation schedule requested by the UE device. The UE device may in turn may communicate with the base station according to the received uplink grants.

### PRIORITY CLAIM

This application claims benefit of priority of Chinese Application for Invention No. 201510415505.9 titled “UE Triggering of Pre-Scheduled Uplink Grants Based on VoLTE Traffic”, filed on Jul. 15, 2015, which is hereby incorporated by reference as though fully and completely set forth herein.

### FIELD OF THE INVENTION

The present application relates to wireless devices, and more particularly to an apparatus, system, and method for a network to provide aperiodic uplink grants to a UE device.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. In general, wireless communication technologies, such as cellular communication technologies, are substantially designed to provide mobile communication capabilities to wireless devices generally powered by a portable power supply, e.g., a battery.

Wireless devices typically include transmitter and receiver circuitry (hereinafter ‘wireless circuitry’ or ‘transceiver circuitry’) that enables wireless communications. One example of a power saving technique developed to reduce the power consumption of transceiver circuitry is known as discontinuous reception (or DRX). In devices utilizing DRX, portions of wireless circuitry may be powered down if there is no information (e.g., packets, data) to be received or transmitted. The wireless circuitry may periodically be powered on to determine if there is information to be received, and subsequently powered back down again if such a determination indicates that no new information is incoming. A device utilizing DRX may determine from a header in a transmitted packet if the information contained therein is incoming for that device. If the information is not relevant to that device, then circuitry may be powered down for at least a portion of the remainder of the packet, and subsequently powered on before the next header. Polling is another technique that may be used, wherein a device may periodically send a beacon to an access point or base station to determine if there is any information waiting for reception. If no information is awaiting reception, portions of the wireless circuitry may be powered down until the next beacon is to be transmitted. In addition to determining if information is awaiting reception by the mobile device, neighbor cell searching may be conducted during the time when the wireless circuitry is powered up while operating in a DRX mode. Neighbor cell searching may be performed in order to enable cell reselection and handover of the mobile device from one cell to another.

In general, DRX has been introduced in several wireless standards such as UMTS (Universal Mobile Telecommunications System), LTE (Long-term evolution), WiMAX™, etc., which powers down most of user equipment (UE) circuitry when there are no packets to be received or transmitted, and only wakes up at specified times or intervals to listen to the network. DRX can be enabled in different network connection states, including connected mode and idle mode. In connected DRX (C-DRX) mode, the UE device listens to the downlink (DL) packets following a specified pattern determined by the base-station (BS). In idle DRX (I-DRX) mode, the UE device listens to the page from the BS to determine if it needs to reenter the network and acquire the uplink (UL) timing. Because DRX allows the UE to switch off its transceiver circuitry for short intervals when there is no data to receive or transmit, and start “wake up and sleep” cycles to check whether there is data to send or receive, operating in C-DRX mode helps decrease battery usage.

Another aspect of wireless data transmission is scheduling. Generally, in communications between a UE device and a wireless network, scheduling is used to designate time slots for uplink communications transmitted by the UE device to the base station. For uplink communications, the UE may first make a scheduling request to the base station. In response, the base station may respond with an uplink grant sent to the UE, granting the UE permission to transmit uplink data. In most cases, scheduling is fully dynamic. In a downlink direction, resources are assigned when data is available. For data to be sent in the uplink direction, the UE dynamically requests transmission opportunities whenever data arrives in the UE's uplink buffer. Information about data being sent in the downlink direction, and uplink transmission opportunities are carried in the radio layer control channel, which is sent at the beginning of each subframe. While dynamic scheduling is efficient for infrequent and bandwidth consuming data transmissions, which may result in large data bursts (e.g. web surfing, video streaming, emails), it is less suited for real time streaming applications such as voice calls. In the latter cases, data is sent in short bursts at regular intervals. If the data rate of the stream is very low, as is the case for voice calls, the overhead of the scheduling messages can become very high, as only little data is sent for each scheduling message.

One solution to this issue has been semi-persistent scheduling (SPS). Instead of scheduling each uplink or downlink transmission, a transmission pattern is defined instead of single opportunities. This significantly reduces the scheduling assignment overhead. During silence periods, the wireless voice CODECs in UEs stop transmitting voice data, and only send silence description information with much longer time intervals in between. During those times of silence the persistent scheduling can be switched-off. In the uplink, the SPS grant scheme is implicitly canceled if no data is sent for a network-configured number of empty uplink transmission opportunities. In downlink direction, SPS is canceled with an RRC (Radio Resource Control) message.

With SPS, the base station provides to the UE a pre-determined schedule of periodic time slots in which the UE may perform uplink communications. This allows the UE to generate uplink transmissions to the base station without the overhead of scheduling requests and specific uplink grants. However, for certain types of uplink traffic, current implementations of scheduling requests/uplink grants and/or SPS may be inefficient. Some application categories may benefit from more efficient uplink grant scheduling mechanisms. Thus, improvements in the field are desired.

### SUMMARY OF THE INVENTION

Embodiments described herein relate to an apparatus, system, and method for providing improved uplink communication scheduling between a UE and a base station. In some embodiments, a UE may comprise at least one antenna, at least one transmitter, at least one receiver, and one or more processors coupled to the at least one transmitter and the at least one receiver. The UE may be configured to transmit information to the base station, which may be useable by the base station to determine an uplink grant schedule for subsequent communications between the UE and the base station. The UE may transmit uplink communications to the base station in response to a received schedule of uplink grants.

Accordingly, a pre-allocated grant schedule or pre-allocation grant schedule for communications between a wireless communication device and a base station may be determined and applied according to requests made by the wireless communication device. The wireless communication device may provide information to a base station, with the information including a request to the base station to end a previous pre-allocation schedule and/or including a request to the base station to start new pre-allocation schedule. In various embodiments, the information and/or request may be transmitted by the wireless communication device over MAC (Media Access Control) CE Control Element) signaling. Furthermore, a request for stopping a previous pre-allocation schedule and starting a new pre-allocation schedule may be transmitted by the wireless communication device at the same time, for example when transitioning from non-talk to a talk mode while a previous pre-allocation schedule is in effect. In some embodiments, a request for stopping a previous pre-allocation schedule and starting a new pre-allocation schedule may be transmitted in subsequent frames, respectively, for example when transitioning from talk to non-talk mode.

The base station may determine a pre-allocation schedule using the information received from the wireless communication device, and may change the configuration of its communication with the wireless communication device in response to the information received from the wireless communication device. The base station may thereby stop a previous pre-allocation schedule when applicable and so requested by the wireless communication device, and/or it may start (implement) a new pre-allocation schedule as requested and instructed by the wireless communication device according to the determined pre-allocation schedule. The base station may then begin communicating uplink grants to the wireless communication device according to the (new) pre-allocation schedule requested by the wireless communication device. In turn, the wireless communication device communicates with the base station according to the received uplink grants per the (new and requested) pre-allocation schedule.

The techniques described herein may be implemented in and/or used with a number of different types of devices, including but not limited to cellular phones, portable media players, portable gaming devices, tablet computers, wearable computing devices, remote controls, wireless speakers, set top box devices, television systems, and computers.

Accordingly, various embodiments may include computer program instructions for performing any of the methods disclosed herein, an apparatus having means for performing any of the method elements of any of the methods disclosed herein. In some embodiments, a method may include any action or combination of actions as described in the Detailed Description of Various Embodiments herein. In some embodiments, a method may include steps substantially described herein with reference to each or any combination of the Figures herein or with reference to each or any combination of paragraphs in the Detailed Description of Various Embodiments herein. Furthermore, various embodiments of a wireless device may perform any action or combination of actions as described herein in the Detailed Description of Various Embodiments. Various embodiments of a wireless device may include any component or combination of components as described herein in the Detailed Description of Various Embodiments as included in a wireless device. In some embodiments, a non-volatile computer-readable medium may store instructions that, when executed, cause the performance of any action or combination of actions as substantially described herein in the Detailed Description of Various Embodiments. In addition, various embodiments of an integrated circuit may perform any action or combination of actions as described herein in the Detailed Description of Various Embodiments.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present invention can be obtained when the following detailed description of the embodiments is considered in conjunction with the following drawings.

FIG. 1 illustrates an exemplary (and simplified) wireless communication system, in accordance with some embodiments;

FIG. 2 illustrates one example of a base station in communication with a user equipment device (wireless communication device), in accordance with some embodiments;

FIG. 3 illustrates one example of a wireless communication system in which a wireless communication device communicates with two base stations using two different radio access technologies, in accordance with some embodiments;

FIG. 4 is an exemplary block diagram of a base station, in accordance with some embodiments;

FIG. 5 is an exemplary block diagram of a wireless communication device (user equipment device), in accordance with some embodiments;

FIG. 6 is an exemplary timing diagram illustrating Connected-Mode Discontinuous Reception (C-DRX) signaling, in accordance with prior art;

FIG. 7 shows one example of a signal timing chart illustrating uplink grant scheduling, in accordance with prior art;

FIG. 8 shows one example of a signal timing chart illustrating uplink pre-schedule request and grant signaling when transitioning from non-talk to a first talk mode, in accordance with some embodiments;

FIG. 9 shows one example of a signal timing chart illustrating uplink pre-schedule request and grant signaling when transitioning from non-talk to a second talk mode, in accordance with some embodiments;

FIG. 10 shows one example of a signal timing chart illustrating uplink pre-schedule request and grant signaling when transitioning from talk to a non-talk mode, in accordance with some embodiments; and

FIG. 11 is one example of a flowchart illustrating uplink grant scheduling using information provided by the UE to the base station, in accordance with some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF VARIOUS EMBODIMENTS

### Acronyms

The following acronyms may be used in the present disclosure.
3GPP: Third Generation Partnership Project
3GPP2: Third Generation Partnership Project 2
C-DRX: Connected Mode Discontinuous Reception
GSM: Global System for Mobile Communications
UMTS: Universal Mobile Telecommunications System
TDS: Time Division Synchronous Code Division Multiple Access
LTE: Long Term Evolution
RAT: Radio Access Technology
SPS: Semi-Persistent Scheduling
CE: Control Element
TX: Transmit
RX: Receive
ACK: Acknowledge
RTP: Real-time Transport Protocol
AMR: Adaptive Multi-Rate
NACK: Negative Acknowledge
MAC: Media Access Control
PDCCH: Physical Downlink Control Channel
PDSCH: Physical Downlink Shared Channel
PDU: Protocol Data Unit
PHICH: Physical HARQ Indicator Channel
PHY: Physical (Layer)
PUCCH: Physical Uplink Control Channel
PUSCH: Physical Uplink Shared Channel
SFN: System Frame Number
SID: System Identification Number
RNTI: Radio Network Temporary Identifier

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices which are mobile or portable and which performs wireless communications. Examples of UE devices include mobile telephones or smart phones (e.g., iPhone™, Android™-based phones), portable gaming devices (e.g., Nintendo DS™, Play Station Portable™, Gameboy Advance™, iPhone™), laptops, PDAs, portable Internet devices, music players, data storage devices, other handheld devices, as well as wearable devices such as wrist-watches, headphones, pendants, earpieces, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

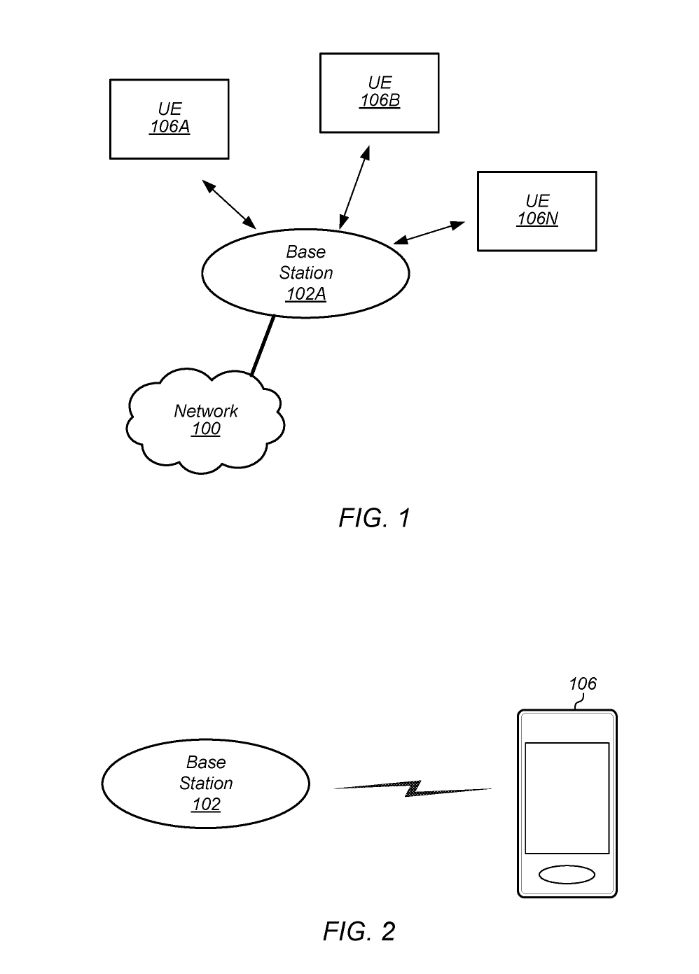

FIGS. 1 and 2—Communication System

FIG. 1 illustrates an exemplary (and simplified) wireless communication system, in accordance with some embodiments. It is noted that the system of FIG. 1 is merely one example of a possible system, and embodiments may be implemented in any of various systems, as desired.

As shown, the exemplary wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices (UEs) and/or between the UEs and the network 100.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (WCDMA, TD-SCDMA), LTE, LTE-Advanced (LTE-A), HSPA, 3GPP2 CDMA2000 (e.g., 1×RTT, 1×EV-DO, HRPD, eHRPD), Wi-Fi, WiMAX etc.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a wide geographic area via one or more cellular communication standards.

Thus, while base station 102A may act as a “serving cell” for UEs 106A-N as illustrated in FIG. 1, each UE 106 may also possibly come within communication range of, and be capable of receiving signals from, one or more other cells (which might be provided by base stations 102B-N and/or any other base stations), which may be referred to as “neighboring cells.” Such cells may also be capable of facilitating communication between user devices and/or between user devices and the network 100, according to the same wireless communication technology as base station 102A and/or any of various other possible wireless communication technologies. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

Note that a UE 106 may be capable of communicating using multiple wireless communication standards. For example, a UE 106 may be configured to communicate using a wireless networking (e.g., Wi-Fi) and/or peer-to-peer wireless communication protocol (e.g., BLUETOOTH™, WiFi™, peer-to-peer, etc.) in addition to at least one cellular communication protocol (e.g., GSM, UMTS (WCDMA, TD-SCDMA), LTE, LTE-A, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102 (e.g., one of the base stations 102A through 102N), in accordance with some embodiments. The UE 106 may be a device with cellular communication capability such as a mobile phone, a hand-held device, a wearable device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 might be configured to communicate using either of CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate (and possibly multiple) transmit and/or receive chains (e.g., including separate RF and/or digital radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 1×RTT (or LTE or GSM), and separate radios for communicating using each of Wi-Fi and Bluetooth. Other configurations are also possible.

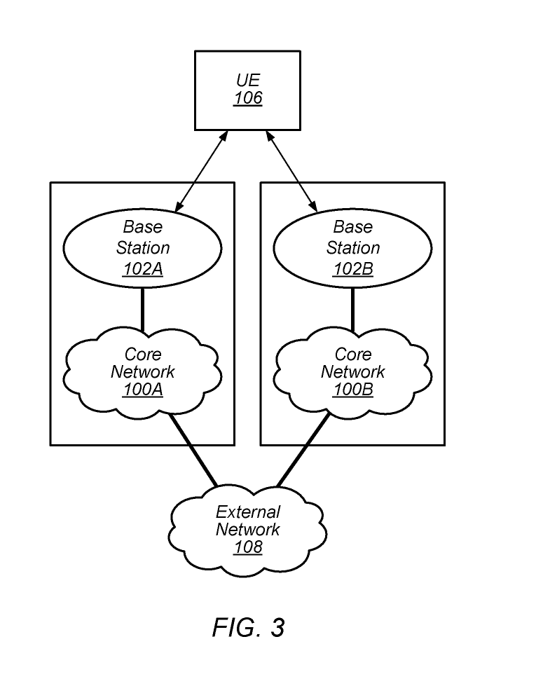

### FIG. 3—Communication System

FIG. 3 illustrates an example simplified wireless communication system, in accordance with some embodiments. It is noted that the system of FIG. 3 is merely one example of a possible system, and embodiments may be implemented in any of various systems, as desired.

As shown, the exemplary wireless communication system includes base stations 102A and 102B which communicate over a transmission medium with one or more user equipment (UE) devices, represented as UE 106. The base stations 102 may be base transceiver stations (BTS) or cell sites, and may include hardware that enables wireless communication with the UE 106. Each base station 102 may also be equipped to communicate with a core network 100. For example, base station 102A may be coupled to core network 100A, while base station 102B may be coupled to core network 100B. Each core network may be operated by a respective cellular service provider, or the plurality of core networks 100A may be operated by the same cellular service provider. Each core network 100 may also be coupled to one or more external networks (such as external network 108), which may include the Internet, a Public Switched Telephone Network (PSTN), and/or any other network. Thus, the base stations 102 may facilitate communication between the UE devices 106 and/or between the UE devices 106 and the networks 100A, 100B, and 108.

The base stations 102 and the UEs 106 may be configured to communicate over the transmission medium using any of various radio access technologies (“RATs”, also referred to as wireless communication technologies or telecommunication standards), such as GSM, UMTS (WCDMA), TDS, LTE, LTE Advanced (LTE-A), 3GPP2 CDMA2000 (e.g., 1×RTT, 1×EV-DO, HRPD, eHRPD), IEEE 802.11 (WLAN or Wi-Fi), IEEE 802.16 (WiMAX), etc.

Base station 102A and core network 100A may operate according to a first RAT (e.g., LTE) while base station 102B and core network 100B may operate according to a second (e.g., different) RAT (e.g., GSM, TDS, CDMA 2000 or other legacy or circuit switched technologies). The two networks may be controlled by the same network operator (e.g., cellular service provider or “carrier”), or by different network operators, as desired. In addition, the two networks may be operated independently of one another (e.g., if they operate according to different RATs), or may be operated in a somewhat coupled or tightly coupled manner.

Note also that while two different networks may be used to support two different RATs, such as illustrated in the exemplary network configuration shown in FIG. 3, other network configurations implementing multiple RATs are also possible. As one example, base stations 102A and 102B might operate according to different RATs but couple to the same core network. As another example, multi-mode base stations capable of simultaneously supporting different RATs (e.g., LTE and GSM, LTE and TDS, LTE and GSM and TDS, and/or any other combination of RATs) might be coupled to a network or service provider that also supports the different cellular communication technologies. In some embodiments, the UE 106 may be configured to use a first RAT that is a packet-switched technology (e.g., LTE) and a second RAT that is a circuit-switched technology (e.g., GSM or TDS).

As discussed above, UE 106 may be capable of communicating using multiple RATs, such as those within 3GPP, 3GPP2, or any desired cellular standards. The UE 106 might also be configured to communicate using WLAN (WiFi), Bluetooth, one or more global navigational satellite systems (GNSS, e.g., GPS or GLONASS), one and/or more mobile television broadcasting standards (e.g., ATSC-M/H or DVB-H), etc. Other combinations of network communication standards are also possible.

Base stations 102A and 102B and other base stations operating according to the same or different RATs or cellular communication standards may thus be provided as a network of cells, which may provide continuous or nearly continuous overlapping service to UE 106 and similar devices over a wide geographic area via one or more radio access technologies (RATs).

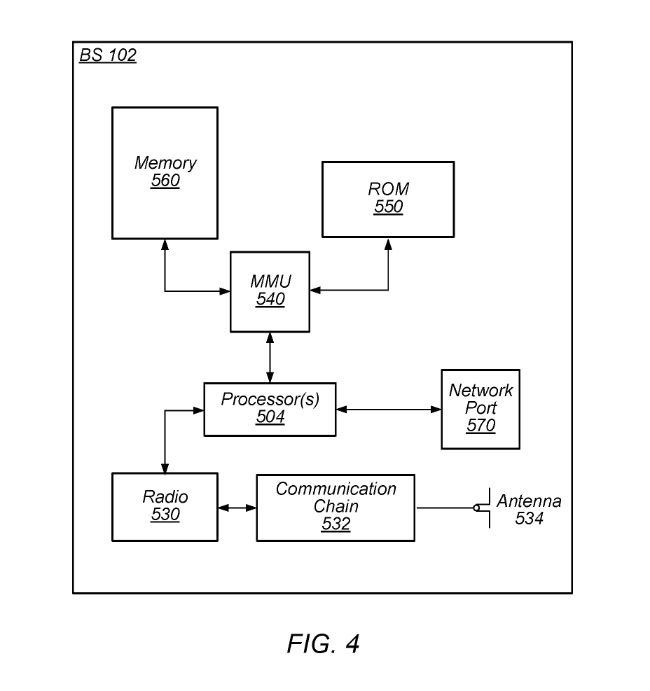

### FIG. 4—Base Station

FIG. 4 illustrates an exemplary block diagram of a base station 102, in accordance with some embodiments. It is noted that the base station of FIG. 4 is merely one example of a possible base station. As shown, the base station 102 may include processor(s) 504 which may execute program instructions for the base station 102. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The base station 102 may include at least one network port 570. The network port 570 may be configured to couple to a telephone network and provide a plurality of devices, such as UE devices 106, access to the telephone network as described above.

The network port 570 (or an additional network port) may also be configured to couple to a cellular network, e.g., a core network of a cellular service provider. The core network may provide mobility related services and/or other services to a plurality of devices, such as UE devices 106. In some cases, the network port 570 may couple to a telephone network via the core network, and/or the core network may provide a telephone network (e.g., among other UE devices 106 serviced by the cellular service provider).

The base station 102 may include at least one antenna 534. The at least one antenna 534 may be configured to operate as a wireless transceiver and may be further configured to communicate with UE devices 106 via radio 530. The antenna 534 communicates with the radio 530 via communication chain 532. Communication chain 532 may be a receive chain, a transmit chain or both. The radio 530 may be configured to communicate via various RATs, including, but not limited to, LTE, GSM, TDS, WCDMA, CDMA2000, etc.

The processor(s) 504 of the base station 102 may be configured to implement part or all of the methods described herein, e.g., by executing program instructions stored on a memory medium (e.g., a non-transitory computer-readable memory medium). Alternatively, the processor(s) 504 may be configured as a programmable hardware element, such as an FPGA (Field Programmable Gate Array), or as an ASIC (Application Specific Integrated Circuit), or a combination thereof. More specifically, the base station 102 may be configured to receive information from the UE and generate an aperiodic uplink grant schedule based on the received information. Alternatively, the base station may be configured to generate an aperiodic uplink grant schedule based on a packet inspection.

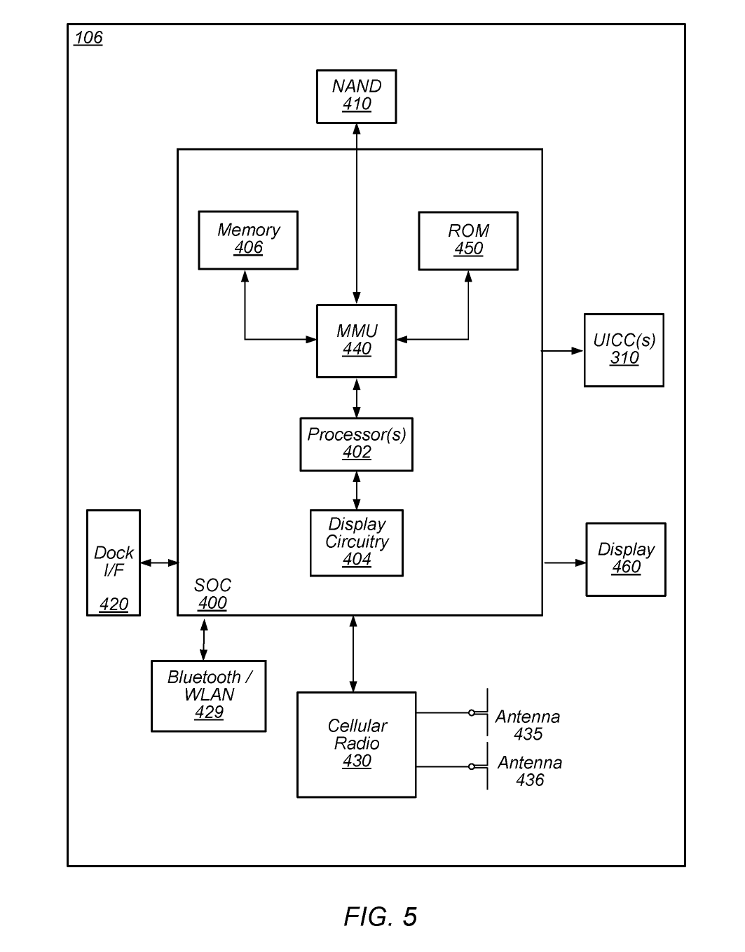

### FIG. 5—User Equipment (UE)

FIG. 5 illustrates an example of a simplified block diagram of a UE 106, in accordance with some embodiments. Various other configurations or architectures may be used for the UE, as desired.

As shown, the UE 106 may include a system on chip (SOC) 400, which may include portions for various purposes. The SOC 400 may be coupled to various other circuits of the UE 106. For example, the UE 106 may include various types of memory (e.g., including Flash 410), a connector interface 420 (e.g., for coupling to a computer system, dock, charging station, etc.), the display 460, cellular communication circuitry 430 such as for LTE, GSM, TDS, CDMA, etc., and short range wireless communication circuitry 429 (e.g., Bluetooth and WLAN circuitry). The UE 106 may further comprise one or more smart cards 310 that comprise SIM (Subscriber Identity Module) functionality, such as one or more UICC(s) (Universal Integrated Circuit Card(s)) cards 310. The cellular communication circuitry 430 may couple to one or more antennas, preferably two antennas 435 and 436 as shown. The short range wireless communication circuitry 429 may also couple to one or both of the antennas 435 and 436 (this connectivity is not shown for ease of illustration).

As shown, the SOC 400 may include processor(s) 402 which may execute program instructions for the UE 106 and display circuitry 404 which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, Flash memory 410) and/or to other circuits or devices, such as the display circuitry 404, cellular communication circuitry 430, short range wireless communication circuitry 429, connector I/F 420, and/or display 460. The MMU 440 may be configured to perform memory protection and page table translation or set up. In some embodiments, the MMU 440 may be included as a portion of the processor(s) 402. In some embodiments, as noted above, the UE 106 comprises at least one smart card 310, such as a UICC 310, which executes one or more Subscriber Various other SIM configurations are also contemplated.

As described herein, the UE 106 may include hardware and/or software components for implementing features for communicating information to a base station. The UE may provide information to the base station which may affect the manner in which uplink grant scheduling, such as semi-persistent scheduling, is performed by the base station. Thus a schedule provided to the UE for uplink communication (e.g., semi-persistent scheduling) may be based information provided by the UE. The processor 402 of the UE device 106 may be configured to implement part or all of the features described herein, e.g., by executing program instructions stored on a memory medium (e.g., a non-transitory computer-readable memory medium). Alternatively (or in addition), processor(s) 402 may be configured as a programmable hardware element, such as an FPGA (Field Programmable Gate Array), or as an ASIC (Application Specific Integrated Circuit). Alternatively (or in addition) the processor(s) 402 of the UE device 106, in conjunction with one or more of the other components 400, 404, 406, 410, 420, 430, 435, 440, 450, 460 may be configured to implement part or all of the features described herein.

### DRX

The parameters for DRX cycles may be configured by the BS (e.g. BS 102) through different timers. The DRX inactivity timer indicates the time in number of consecutive subframes to wait before enabling DRX. Short DRX cycles and long DRX cycles are defined to allow the BS to adjust the DRX cycles based on the application categories and associated characteristics. A DRX short cycle timer may be defined to determine when to transition to the long DRX cycle. When there is no reception of packets for an extended period of time after the successful reception of a packet, the BS may initiate RRC connection release and the UE may enter the RRC IDLE state, during which the idle DRX can be enabled. The On-Duration timer may be used to determine the number of frames over which the UE will read the DL control channel every DRX cycle before entering power saving mode. Exemplary allowed values are 1, 2, 3, 4, 5, 6, 8, 10, 20, 30, 40, 50, 60, 80, 100, and 200. During idle DRX mode, the UE may monitor one paging occasion (PO) per DRX cycle, which is one subframe.

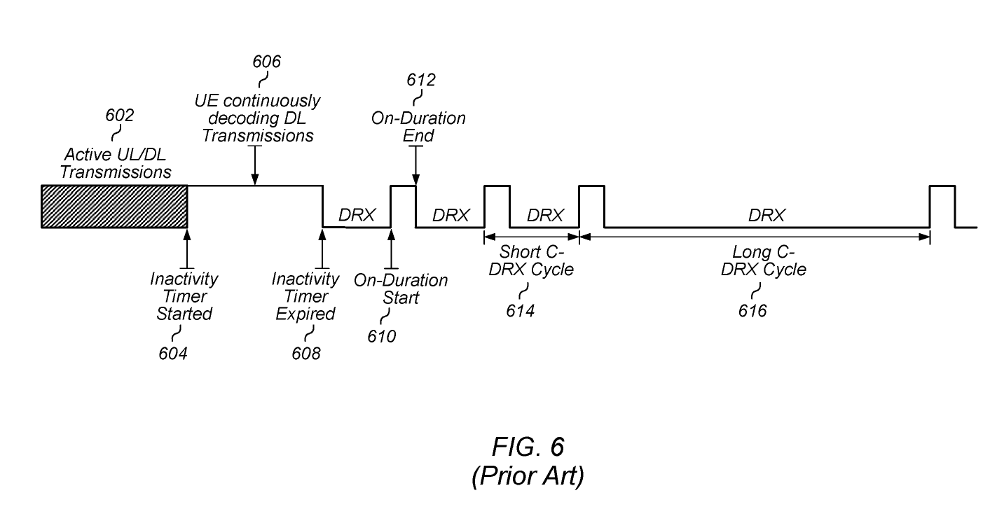

FIG. 6 illustrates various aspects of general C-DRX operation. As indicated by 602, the UE 106 may operate in an active state and may perform one or more uplink and/or downlink (UL/DL) transmissions (e.g., transmit uplink data and/or receive downlink data). At 604, an inactivity timer may be initiated. The inactivity timer may be initiated at the end of the active transmissions in 602. Note that the inactivity timer may have been initiated one or more times during the active transmissions in 602, but may have been reset each time as a result of continuing activity (transmissions) until no more activity was observed at 604, at which point it may run until expiration at 608. The inactivity timer may have any length, as desired; some examples of possible inactivity timer length might include 100 ms, 80 ms, 50 ms, 40 ms, or any other value, e.g., as specified by the 3GPP 36.331 specification.

In 606, between initiation (at 604) and expiration (at 608) of the inactivity timer, the UE 106 may not be performing any uplink or downlink transmissions, but may continue to operate in the active state, and may monitor one or more communication channels (e.g., a PDCCH) for downlink grants. At 608, the inactivity timer may expire. At this point the UE 106 may transition to a reduced-power state (DRX), as a result of having observed a sufficient period of data communication inactivity (e.g., as indicated by the expiration of the inactivity timer). During the period of time that the UE 106 is operating in the reduced-power state, the UE 106 may power down and/or reduce power to one or more components, such as baseband logic components and/or radio components.

At 610, the UE 106 may “wake-up” and re-enter the active state. The UE 106 may wake up at a time specified by a schedule, e.g., of which it may be informed by a base station (e.g., an eNode-B, in LTE). At the specified time (or after a specified interval), the base station may notify the UE 106 of a downlink grant for the UE 106, if there is any downlink data pending, so the UE 106 may check (e.g., monitor a communication channel such as a PDCCH) for downlink grants during this time. One or more other functions may also be performed during this time, if desired. This time period may also be referred to as the “on-duration” in C-DRX operation. According to some embodiments, the on-duration may last a specified length of time, such as 5 ms, or 10 ms, or another length of time, e.g., as specified by the 3GPP 36.331 specification; alternatively, the on-duration may last until certain functions have been performed, and may end when no further specified functions need to be performed. At 612, the on-duration may end, and if no downlink grants were received during the on-duration, the UE 106 may go back to “sleep” and transition back into the reduced-power state. Any number of subsequent cycles of sleeping (DRX) and waking (on-duration) may be performed, as desired.

Note that the UE 106 may also be configured to transition between C-DRX cycles with different lengths. For example, as shown, the UE 106 may perform up to a pre-determined number (such as 2, 4, 8, 16, etc.) of “short C-DRX” cycles 614 (which may last 20 ms, 40 ms, 80 ms, or any other length of time), and if no uplink or downlink transmission are performed by the end of the pre-determined number of cycles, the UE 106 may perform one or more “long C-DRX” cycles 616 (which may last 80 ms, 160 ms, 320 ms, or any other length of time, e.g., as specified by 3GPP 36.331), which may specify a longer period of reduced-power state operation before waking up for active state on-duration operations. The long C-DRX cycles may continue until further active communication (e.g., which may be initiated either by the UE 106 or the network) occurs, or one or more other conditions occur which might cause the UE 106 to transition away from the long C-DRX cycles.

If active communications are again initiated at some subsequent time, the UE 106 may perform similar steps (e.g., monitoring activity/inactivity via an inactivity timer and initiating one or more C-DRX cycles if sufficient inactivity is seen between active communications) if appropriate, e.g., depending on communication activity.

### Uplink Grant Scheduling During VoLTE Calls

In some packet-switched wireless RATs, such as LTE, when a wireless communication device (e.g. UE device) prepares to transmit uplink (UL) data, the UE triggers a scheduling request (SR) to obtain a UL grant from the network, e.g. from a base station servicing the cell in which the UE is located at the time of data transmission. For VoLTE, which is a discontinuous service, the UE will remain in a C-DRX state. For every C-DRX cycle the UE triggers an SR, then receive the UL grant, and subsequently transmits out the UL data. In case of a C-DRX long cycle (e.g. 40 ms, as illustrated in FIG. 6) the elapsed time or time period from transmission of the SR trigger to transmission of the UL data, may correspond to 10 subframes with UL/DL configuration value of ‘2’ (in reference to UL/DL configurations in LTE). In general, the UL/DL configuration value refers to a switch-point periodicity from DL to UL.

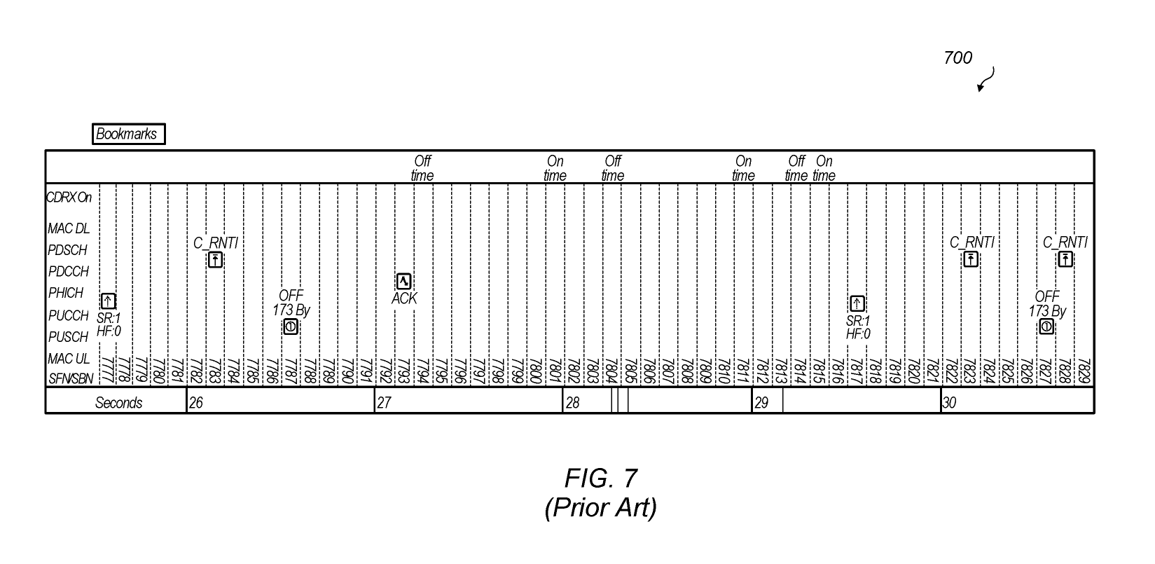

FIG. 7 shows one example of a signal timing chart illustrating uplink grant scheduling according to prior art, as described above. Specifically, FIG. 7 illustrates UL grant scheduling for a talk scenario. As illustrated in FIG. 7, the buffer status report (BSR) value, together with the UL data, is ‘0’. As shown in FIG. 7, for the talk state, the UE device loops from triggering a SR to receiving a UL grant to transmitting UL data over PUSCH. In the exemplary timing chart shown in FIG. 7, the timeline from triggering the SR request until the UE transmits PUSCH data is 10 subframes.

### Triggering of Base Station Pre-Scheduling by the UE

In one set of embodiments, the UE may be operated to trigger the eNB (base station) pre-schedule for VoLTE. This may in effect reduce the timeline between transmitting an SR by the UE and receiving an UL grant by the UE. For example, the timeline may be reduced to 6 ms with a UL/DL configuration value of 2. In general, the pre-schedule pattern may be changed based on request(s) transmitted by the UE.

In one set of embodiments, a base station may configure CDRX with long cycle (e.g. 20 ms) in a normal field, and CDRX off in a specific mode (e.g. high speed mode). In high speed mode, the base station may enable pre-schedule with a specified (e.g. 5 ms) periodicity. For VoLTE, the RTP packet may be transmitted every 20 ms, therefore three (3) UL grants may not be useful and may cause the UE to consume more power. In this scenario, UE may be operated to trigger the eNB pre-schedule for VoLTE with 40 ms periodicity for talk state or 160 ms periodicity for non-talk state.

Since the network side (e.g. a servicing base station) has a pre-schedule mechanism for VoLTE service, when the UE detects a change to talk state, the UE may send a request to the base station to trigger the pre-schedule. When the UE changes from talk state to silence/listen state, it may request the base station to change the pre-schedule pattern or disable the pre-schedule altogether. This may be implemented for all the C-DRX configurations and/or may be implemented without a C-DRX configuration, especially in high-speed train mode. In some embodiments, the request to trigger pre-schedule or disable pre-schedule may be carried or transmitted via MAC CEs.

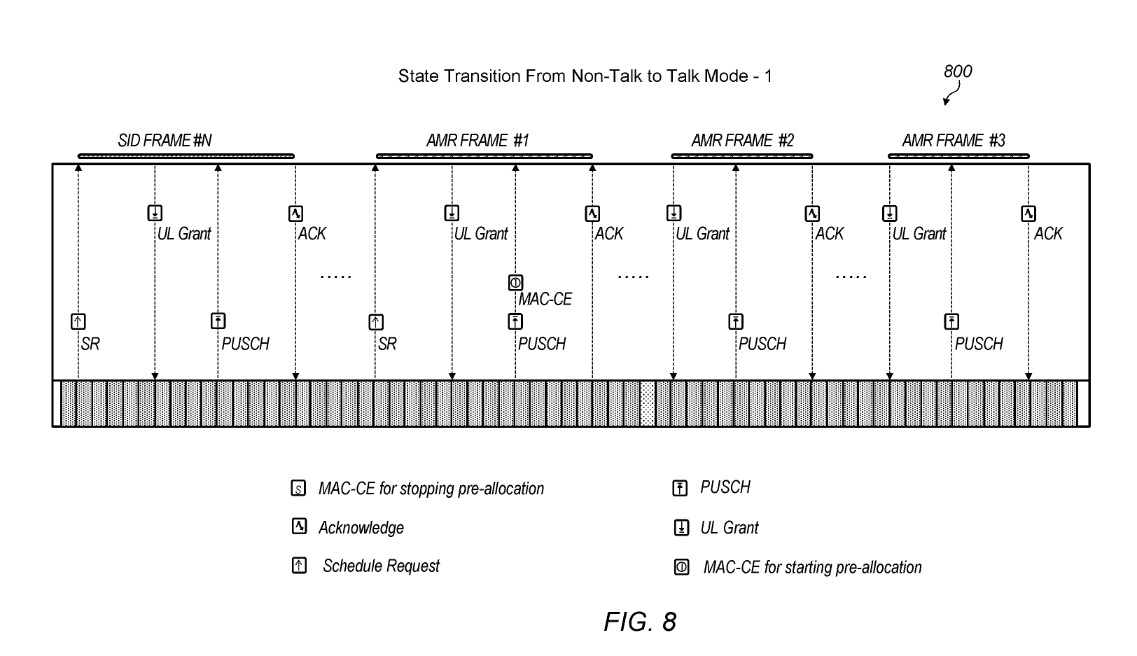

FIG. 8—Transition from Non-Talk to Talk Mode 1

FIG. 8 shows one example of a signal timing chart illustrating uplink pre-schedule request and grant signaling according to one set of embodiments. Specifically, signal timing chart 800 illustrates state transition from non-talk to talk mode 1 according to some embodiments. As indicated for the embodiments illustrated in FIG. 8, pre-allocation for non-talk mode is not enabled, and the UE device may generate signaling via MAC CE for requesting start of pre-allocation. Subsequent to an SID frame, in AMR frame #1, after sending an SR and receiving a UL grant, the UE may transmit UL data over PUSCH, and also transmit information, in a MAC CE, requesting the base station to start pre-allocation. That is, the UE may request, through MAC CE signaling, that the base station start a pre-allocation schedule per the UE's request as opposed to a timing that may have been otherwise established by the base station. The UE may subsequently receive an acknowledge (ACK) from the base station, which may also enable the pre-allocation with required resource and periodicity, resulting in the periodic transmissions of UL data in AMR frames #2 and #3. It should be noted that signal timing chart 800 is illustrative of one example sequence, and various other embodiments may include fewer or additional AMR and/or SID frames (for example) being part of the pre-allocated transmit schedule(s).

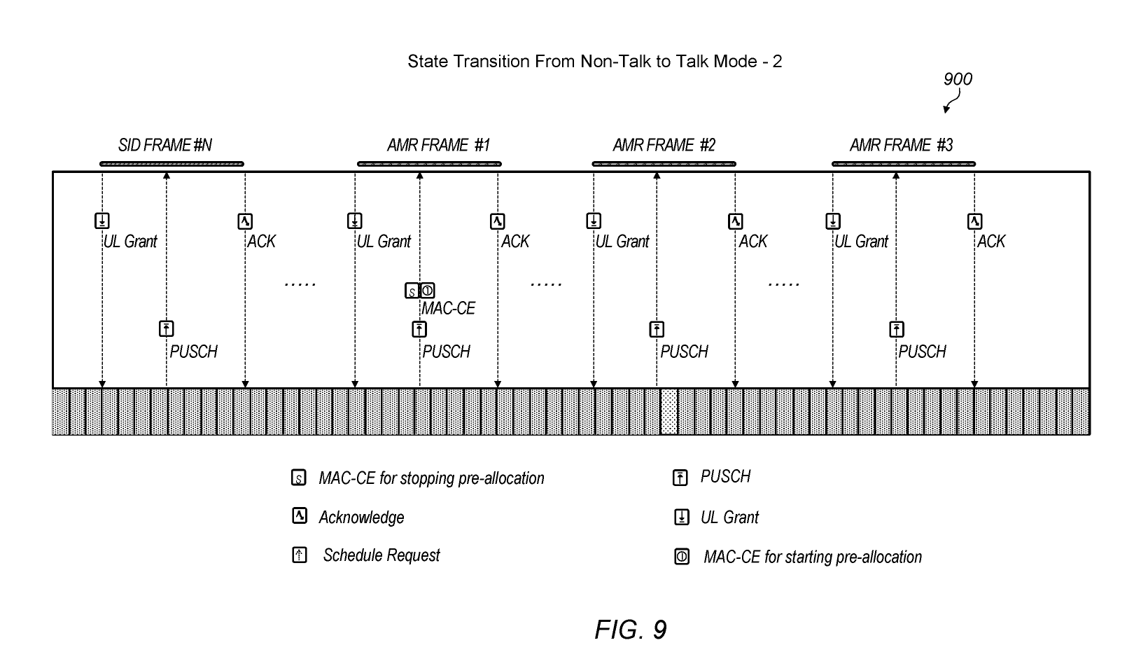

FIG. 9—Transition from Non-Talk to Talk Mode 2

FIG. 9 shows one example of a signal timing chart illustrating uplink pre-schedule request and grant signaling according to another set of embodiments. Specifically, signal timing chart 900 illustrates state transition from non-talk to talk mode 2 according to some embodiments. As indicated for the embodiments illustrated in FIG. 9, pre-allocation for non-talk mode is enabled, and the UE device may generate signaling via MAC CE for requesting start of pre-allocation of a next schedule while at the same time generate signaling via MAC CE for stopping pre-allocation of a previous (or present) schedule. Subsequent to an SID frame, in AMR frame #1, after sending an SR and receiving a UL grant, the UE may transmit UL data over PUSCH, and also transmit information, in a MAC CE, requesting the base station to stop pre-allocation of a previous (or present) schedule and start pre-allocation of a next schedule. That is, the UE may request, through MAC CE signaling, that the base station stop a previous pre-allocation schedule and start a new pre-allocation schedule per the UE's request as opposed to a timing that may have been otherwise established by the base station for those schedule(s). The UE may subsequently receive an acknowledge (ACK) from the base station, which may disable the previous pre-allocation first, and subsequently enable the new pre-allocation with required resource and periodicity, resulting in the periodic transmissions of UL data in AMR frames #2 and #3. It should be noted that signal timing chart 900 is illustrative of one example sequence, and various other embodiments may include fewer or additional AMR and/or SID frames (for example) being part of the pre-allocated transmit schedule(s).

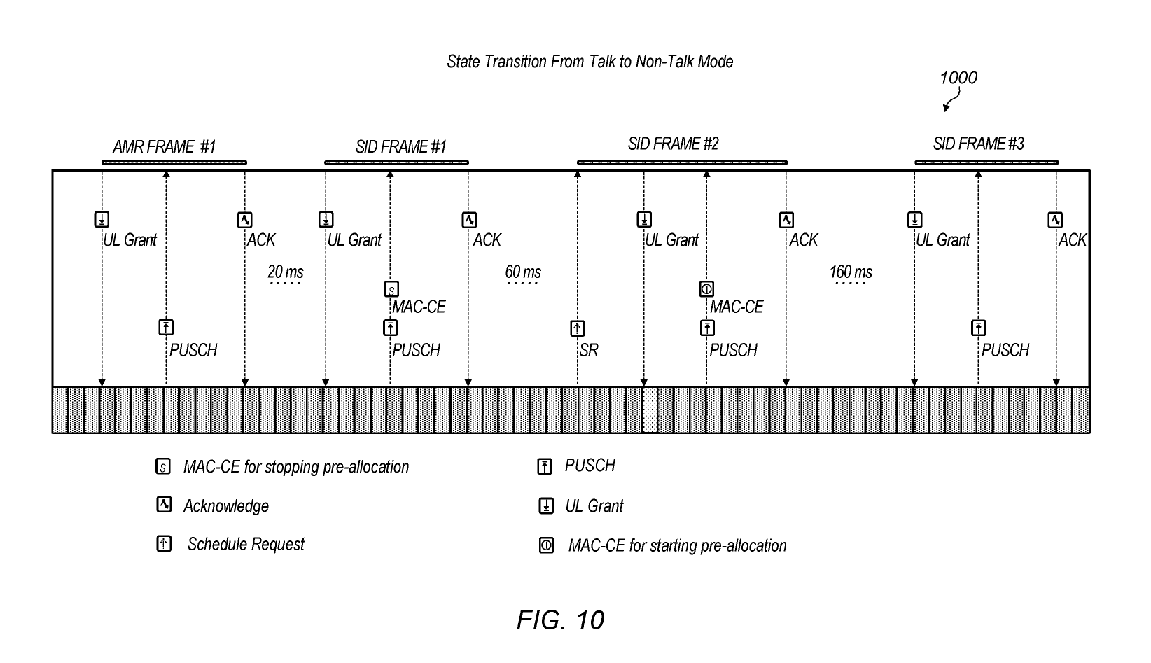

FIG. 10—Transition from Talk to Non-Talk Mode

FIG. 10 shows one example of a signal timing chart illustrating uplink pre-schedule request and grant signaling according to yet another set of embodiments. Specifically, signal timing chart 1000 illustrates state transition from talk to non-talk mode according to some embodiments. As indicated for the embodiments illustrated in FIG. 10, pre-allocation for talk mode is enabled, and the UE device may generate signaling via MAC CE for requesting stop of a previous pre-allocation before requesting, via MAC CE signaling, a request for starting pre-allocation of a new schedule. As illustrated in FIG. 10, before entering non-talk mode, the SID frame may exhibit the following pattern:
AMR #N→20 ms→SID #1→60 ms→SID #2→160 ms→SID#3→160 ms.

In SID frame #1, the UE may indicate to the base station (i.e. to the network) that the old pre-allocation is to be stopped. In SID frame #2, the UE may indicate to the base station that a new pre-allocation is to be started. That is, in SID frame #1 the UE may request, through MAC CE signaling, that the base station stop a previous pre-allocation schedule, and in a subsequent SID frame (#2) the UE may request, through MAC CE signaling, that the base station start a new pre-allocation schedule per the UE's request. The UE may subsequently receive an acknowledge (ACK) from the base station, which enable the new pre-allocation with required resource and periodicity as indicated by the resulting periodic transmissions of UL data in SID frame #3, after having previously stopped the previous pre-allocation. It should be noted that signal timing chart 1000 is illustrative of one example sequence, and various other embodiments may include fewer or additional AMR and/or SID frames (for example) being part of the pre-allocated transmit schedule(s).

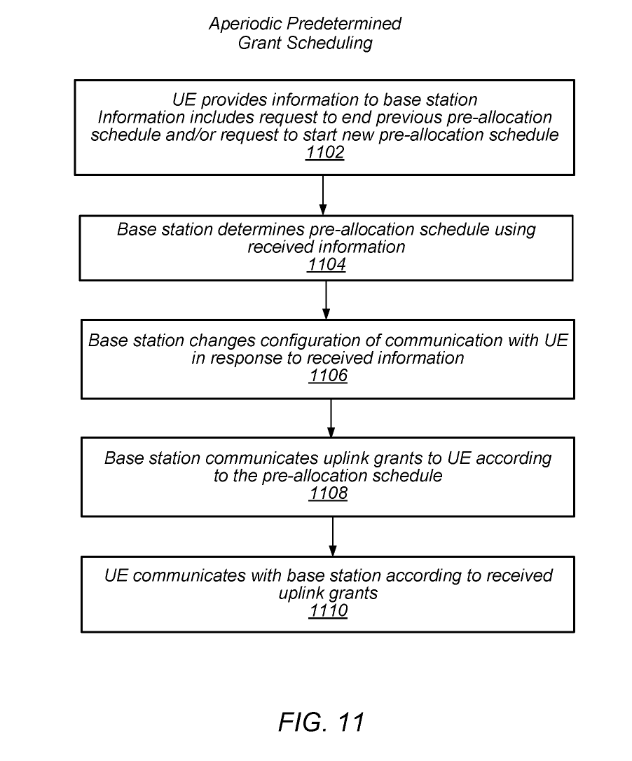

### FIG. 11—Uplink Grant Scheduling According to UE Requested Pre-Allocation

FIG. 11 illustrates one example method by which a pre-allocated grant schedule for communications between a UE and a base station may be determined and applied. At 1102, the UE provides information to a base station. The information may include a request to the base station to end a previous pre-allocation schedule and/or it may include a request to the base station to start new pre-allocation schedule. In some embodiments, the information and/or request may be transmitted by the UE over MAC CE signaling. Furthermore, a request for stopping a previous pre-allocation (schedule) and starting a new pre-allocation (schedule) may be transmitted by the UE at the same time, for example when transitioning from non-talk to a talk mode while a previous pre-allocation schedule is in effect. Alternatively, a request for stopping a previous pre-allocation (schedule) and starting a new pre-allocation (schedule) may be transmitted in subsequent frames, respectively, for example when transitioning from talk to non-talk mode.

At 1104, the base station may determine a pre-allocation schedule using the received information. At 1106, the base station changes the configuration of its communication with the UE in response to the received information. This may include the base station stopping a previous pre-allocation schedule when applicable and so requested by the UE, and/or starting a new pre-allocation schedule as requested and instructed by the UE, according to the pre-allocation schedule determined at 1104. Then, at 1108, the base station may begin communication UL grants to the UE according to the (new) pre-allocation schedule requested by the UE. In turn, the UE then communicates with the base station according to the received UL grants per the pre-allocation schedule.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs. For example, some or all of the units included in the UE may be implemented as ASICs, FPGAs, or any other suitable hardware components or modules.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A user equipment device (UE), comprising:
a radio, comprising one or more antennas for facilitating wireless communications of the UE; and
electronic processing circuitry coupled to the radio, and configured to interoperate with the radio to cause the UE to:
transmit first information to a base station, wherein the first information comprises a request for the base station to start a new pre-allocation schedule according to which the base station periodically transmits uplink grants to the UE; and
receive, from the base station, periodic uplink grants according to the new pre-allocation schedule requested by the UE.

2. The UE of claim 1, wherein the electronic processing circuitry and radio are configured to interoperate to cause the UE to:
transmit the first information in a media access control (layer) control element.

3. The UE of claim 1, wherein the electronic processing circuitry and radio are configured to interoperate to cause the UE to:
communicate with the base station according to the received uplink grants.

4. The UE of claim 1, wherein the first information further comprises a request for the base station to end a previous pre-allocation schedule before starting the new pre-allocation schedule.

5. The UE of claim 4 wherein the electronic processing circuitry and radio are configured to interoperate to cause the UE to:
transmit the first information when transitioning from non-talk to talk mode.

6. The UE of claim 1, wherein the electronic processing circuitry and radio are configured to interoperate to cause the UE to:
transmit second information to the base station prior to transmitting the first information, wherein the second information comprises a request for the base station to end a previous pre-allocation schedule.

7. The UE of claim 6, wherein the electronic processing circuitry and radio are configured to interoperate to cause the UE to:
transmit the second information in a first frame and transmit the first information in a second frame subsequent to the first frame.

8. The UE of claim 7, wherein the electronic processing circuitry and radio are configured to interoperate to cause the UE to:
transmit the first information and transmit the second information when transitioning from talk to non-talk mode.

9. A method for pre-allocation scheduling of uplink grants for wireless communication devices, the method comprising:
transmitting first information to a base station, wherein the first information comprises a request for the base station to start a new pre-allocation schedule according to which the base station periodically transmits uplink grants to a wireless communication device (UE device); and
receiving, from the base station, periodic uplink grants according to the new pre-allocation schedule requested in transmitting the first information.

10. The method of claim 9, further comprising transmitting the first information in a media access control (layer) control element.

11. The method of claim 9, further comprising communicating with the base station according to the received periodic uplink grants.

12. The method of claim 9, wherein the first information further comprises a request for the base station to end a previous pre-allocation schedule before starting the new pre-allocation schedule.

13. The method of claim 12, further comprising transmitting the first information when transitioning from non-talk to talk mode.

14. The method of claim 9, further comprising:
transmitting second information to the base station prior to transmitting the first information, wherein the second information comprises a request for the base station to end a previous pre-allocation schedule.

15. The method of claim 14, further comprising:
transmitting the second information in a first frame; and
transmitting the first information in a second frame subsequent to the first frame.

16. The method of claim 15, further comprising:
transmitting the first information and transmitting the second information when transitioning from talk to non-talk mode.

17. A base station comprising:
a radio, comprising one or more antennas for facilitating wireless communications of the base station; and
electronic processing circuitry coupled to the radio, and configured to interoperate with the radio to cause the base station to:
receive first information from a wireless communication device, wherein the first information comprises a request from the wireless communication device for the base station to start a new pre-allocation schedule according to which the base station periodically transmits uplink grants to the wireless communication device; and
transmit periodic uplink grants according to the new pre-allocation schedule requested by the wireless communication device.

18. The base station of claim 17, wherein the first information further comprises a request for the base station to end a previous pre-allocation schedule before starting the new pre-allocation schedule.

19. The base station of claim 17, wherein the electronic processing circuitry and radio are configured to interoperate to cause the base station to:
receive second information from the wireless communication device prior to receiving the first information, wherein the second information comprises a request from the wireless communication device for the base station to end a previous pre-allocation schedule.

20. The base station of claim 19, wherein the electronic processing circuitry and radio are configured to interoperate to cause the base station to:
receive the second information in a first transmission frame and receive the first information in a second transmission frame subsequent to the first transmission frame.
